(19) United States
(12) Patent Application Publication
(10) Pub. No.: US 2011/0153069 A1
(43) Pub. Date: Jun. 23, 2011

(54) MEDICATION SUPPORTING APPARATUS, METHOD OF DISCHARGING STORAGE BOX THEREOF, AND MEDICATION SUPPORTING SYSTEM AND METHOD

(75) Inventors: Sun Lee BANG, Daejeon (KR); Jae Hun CHOI, Daejeon (KR); Myung Eun LIM, Daejeon (KR); Dae Hee KIM, Daejeon (KR); Soo Jun PARK, Seoul (KR); Seon Hee PARK, Daejeon (KR)

(73) Assignee: Electronics and Telecommunications Research Institute, Daejeon (KR)

(21) Appl. No.: 12/877,462

(22) Filed: Sep. 8, 2010

(30) Foreign Application Priority Data
Dec. 18, 2009 (KR) 10-2009-0127002

(51) Int. Cl. G06Q 50/00; B65D 83/04; G06F 17/00; B65G 59/00

(52) U.S. Cl. 700/232; 221/2; 221/8; 221/1; 705/2

(57) ABSTRACT

Provided is a medication supporting apparatus, which includes an output unit providing an alarm and a warning according to a medication situation of a user, an input unit receiving a medicine discharge instruction from the user, a medicine storage box cartridge storing a plurality of medicine storage boxes in a stacked fashion, and a discharge module discharging a lowermost one of the medicine storage boxes of the medicine storage box cartridge to an outside according to the medicine discharge instruction. Thus, when the user requests the discharge of medicine, the medicine to be taken at a time according to a corresponding schedule can be discharged without a discharge error.

### CROSS-REFERENCE TO RELATED APPLICATION

This application claims priority to and the benefit of Korean Patent Application No. 10-2009-0127002, filed Dec. 18, 2009, the disclosure of which is incorporated herein by reference in its entirety.

### BACKGROUND

1. Field of the Invention

The present invention relates generally to a medication supporting apparatus and, more particularly, to a medication supporting apparatus capable of correctly discharging medicine according to a medication schedule.

2. Discussion of Related Art

The development of medical technology allows individuals to take an increasing interest in their heath, and thus a demand for health care services for a healthy life has sharply increased. The health care services that have been provided centering on medical institutions are expanding to individuals and homes. With the gradual increase in average life expectancy, the population taking medicine to keep a pattern of healthy life is also increasing.

It is important for the medicine to be regularly taken in prescribed dosages. As such, various medication supporting apparatuses are being studied. Particularly, a medication supporting apparatus for supporting an environment in which all kinds of medicine to be taken at one time are stored and provided to administer a dosage of medicine is being actively studied.

However, such a medication supporting apparatus is based on an operation principle for driving a motor to move a belt and thus discharging dosage bags placed on the belt. In the case where the dosage bags are incorrectly stored in a container, the dosage bags are deformed or caught when discharged. As a result, discharge errors occur, for instance, two dosage bags may be discharged or caught on a discharge port. Further, since the dosage bags are designed to be stored directly in the container, there is a limitation in that only the dosage bags can be stored in the container.

### SUMMARY OF THE INVENTION

The present invention is directed to a medication supporting apparatus and method, capable of providing an alarm according to a medication situation, using a stacked medicine storage box cartridge, and discharging medicine to be taken at a time according to a corresponding schedule without a discharge error when a user requests the discharge of the medicine.

An aspect of the present invention is to provide a medication supporting apparatus, which includes: an output unit providing an alarm and a warning according to a medication situation of a user; an input unit receiving a medicine discharge instruction from the user; a medicine storage box cartridge storing a plurality of medicine storage boxes in a stacked fashion; and a discharge module discharging a lowermost one of the medicine storage boxes of the medicine storage box cartridge to an outside according to the medicine discharge instruction.

In exemplary embodiments, the medication supporting apparatus may further include a communication module, which receives the medication related situation from a medication management server, and sends information about the discharge of the medicine storage box to the server when the medicine storage box is discharged.

In exemplary embodiments, the medication supporting apparatus may further include a control module, which controls data communication with the server and driving commands of the other components.

In exemplary embodiments, the control module may be implemented by a printed circuit board (PCB).

In exemplary embodiments, the medicine storage box cartridge may have an open lower end so as to discharge the lowermost medicine storage box to the outside.

In exemplary embodiments, the medication supporting apparatus may further include a charge opening into which the medicine storage box cartridge is inserted.

In exemplary embodiments, the medication supporting apparatus may further include a discharge opening through which the medicine storage box is exposed to the outside.

In exemplary embodiments, the output unit may include a liquid crystal display (LCD) and a light emitting diode (LED).

In exemplary embodiments, the discharge module may include: a spiral shaft; a driver driving the spiral shaft; a transfer guide connected to the spiral shaft, moving forward or backward by rotation of the spiral shaft, and transferring the medicine storage box; a transfer guide support connected with the transfer guide, and supporting the medicine storage box next above the lowermost medicine storage box when the lowermost medicine storage box is transferred by the forward movement of the transfer guide; and a spring member connected with the transfer guide support, and causing the transfer guide support to be pushed in a forward or backward direction when the transfer guide moves forward or backward.

In exemplary embodiments, the discharge module may further include a sensor, which senses a contact with the discharged lowermost medicine storage box to detect whether or not the lowermost medicine storage box is discharged.

Another aspect of the present invention is to provide a method of discharging a medicine storage box in a medication supporting apparatus. The method includes: giving a forward movement command to a driver according to a medicine discharge request of a user; rotating a spiral shaft in a counterclockwise direction for a predetermined time to advance a transfer guide according to the forward movement command; pushing the medicine storage box out of a discharge opening by the advancing of the transfer guide, and sending information about completion of discharge when the discharge is sensed by a sensor; giving a backward movement command to the driver when the rotation of the spiral shaft is completed; rotating the spiral shaft in a clockwise direction to retreat the transfer guide according to the backward movement command; and when the transfer guide is engaged with a transfer guide support, pushing a spring member to move the transfer guide support and the transfer guide to a rear of the medicine storage box.

In exemplary embodiments, the predetermined time may be a time when the transfer guide reaches a rear end of a storage box discharge module.

Still another aspect of the present invention is to provide a medication supporting system, which includes: a server receiving a medication schedule and a prescription from a doctor or pharmacist and sending information about whether or not a user has taken medicine to a family and caregiver of the user; an output unit providing an alarm and a warning according to a medication situation of a user; an input unit receiving a medicine discharge instruction from the user; a medicine storage box cartridge storing a plurality of medicine storage boxes in a stacked fashion; a discharge module discharging a lowermost one of the medicine storage boxes of the medicine storage box cartridge to an outside according to the medicine discharge instruction; a communication module receiving the medication related situation from the server, and sending information about the discharge of the medicine storage box to the server when the medicine storage box is discharged; and a control module controlling data communication with the server and driving commands of the other components.

Yet another aspect of the present invention is to provide a medication supporting method, which includes: receiving, by a server, medication related details from a doctor or pharmacist and sending the medication related details to a medication supporting apparatus; providing an alarm and a warning to a user according to the medication related details sent from the server; discharging a medicine storage box from the medication supporting apparatus according to a medicine discharge instruction of the user; sending information about the discharge of the medicine storage box to the server; and notifying, by the server, a caregiver of the user of whether or not the user has taken medicine according to the discharge information.

In exemplary embodiments, discharging the medicine storage box may include: sending the medicine discharge instruction to the server according to the medicine discharge instruction of the user; inferring, by the server, a discharge situation from the discharge instruction and a schedule, and sending information about the discharge situation to the medication supporting apparatus; and discharging, by the medication supporting apparatus, the medicine storage box according to the information about the discharge situation.

In exemplary embodiments, the medication related details may include a medication schedule and a prescription.

In exemplary embodiments, the caregiver of the user may be notified of whether or not the user has taken medication through short message service (SMS).

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates the configuration of a medication supporting system according to an exemplary embodiment of the present invention;

FIG. 2A is a detailed block diagram illustrating a medication supporting system according to an embodiment of the present invention;

FIG. 2B is a perspective view illustrating the geometry of a medication supporting apparatus according to an embodiment of the present invention;

FIG. 2C is a perspective view illustrating a medicine storage box cartridge of the medication supporting apparatus of FIG. 2B;

FIG. 3A is a perspective view illustrating a medicine storage box discharge module of the medication supporting apparatus of FIG. 2B;

FIG. 3B is a perspective view illustrating the state before a medicine storage box is discharged by a medicine storage box discharge module of the medication supporting apparatus of FIG. 2B;

FIG. 3C is a perspective view illustrating the state after a medicine storage box is discharged by a medicine storage box discharge module of the medication supporting apparatus of FIG. 2B;

FIG. 4 is a flow chart explaining a method of discharging a medicine storage box in a medication supporting apparatus according to an embodiment of the present invention; and

FIG. 5 is a flow chart explaining a method of providing a medication supporting service in a medication supporting system according to an embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In order to keep the following description of the present invention clear and concise, detailed descriptions of known functions and components may be omitted. When any element of the invention appears in more than one drawing, it is denoted by the same reference numeral in each drawing.

It will be understood that when an element is referred to as being “connected” or “coupled” to another element, it can be directly connected or coupled to the other element, or it can be electrically connected to the other element via an intervening element.

It will be understood that, throughout the specification, unless explicitly stated to the contrary, the term “comprise” and its conjugations such as “comprises” and “comprising” should be interpreted as including any stated elements but not necessarily excluding other elements. In addition, the terms “section,” “device,” and “module” used herein refer to a unit which can be embodied as hardware, software, or a combination thereof, for processing at least one function and performing an operation.

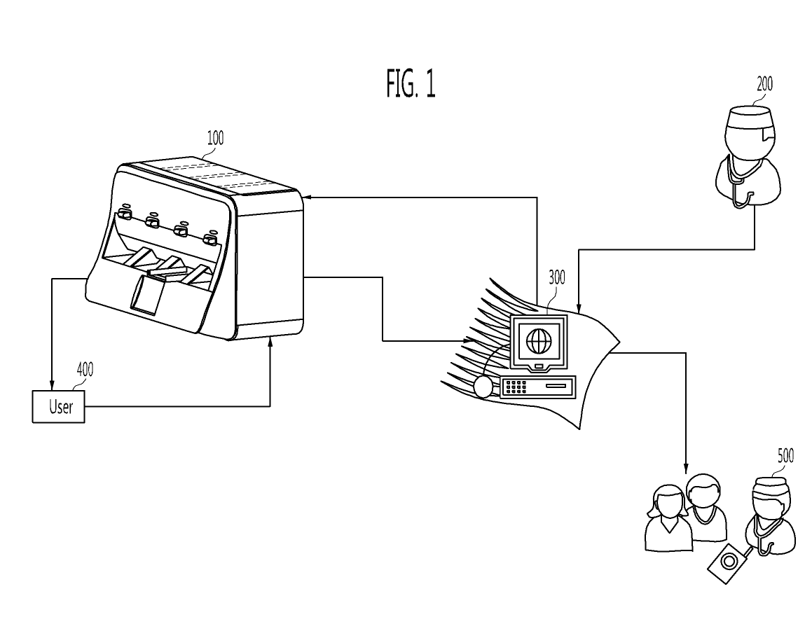

FIG. 1 illustrates the configuration of a medication supporting system according to an exemplary embodiment of the present invention.

Referring to FIG. 1, a medication supporting system according to an exemplary embodiment of the present invention includes a medication supporting apparatus 100 and a medication management server 300.

The medication management server 300 receives both a medication schedule based on a prescription from a doctor and a pharmacist 200 and an identifier (ID) of the medication supporting apparatus 100 which a user 400 owns.

The medication management server 300 receives the ID and state of the medication supporting apparatus 100, infers a current medication situation of the medication supporting apparatus 100 according to the medication schedule and the state of the medication supporting apparatus 100, and sends the current medication situation to the medication supporting apparatus 100.

If the sent medication situation is an alarm situation, the medication supporting apparatus 100 informs the user 400 of the alarm situation through an output unit (which will be described below in detail) installed therein. If a medication event of the user 400 is presented, the medication supporting apparatus 100 sends confirmation of whether or not the user has taken medicine to the medication management server 300.

The medication management server 300 sends the information about whether or not the user has taken medicine to a family and caregiver of the user through short message service (SMS), and records this information to be able to provide a log associated with whether or not the user is to take medicine in the future.

Hereinafter, a detailed construction of the medication supporting apparatus 100 will be described.

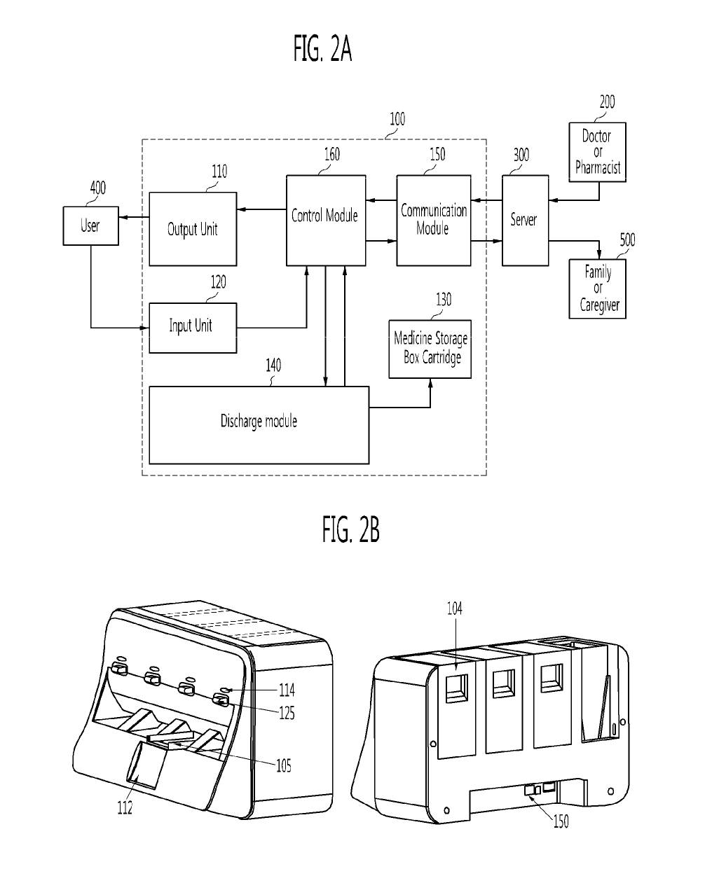

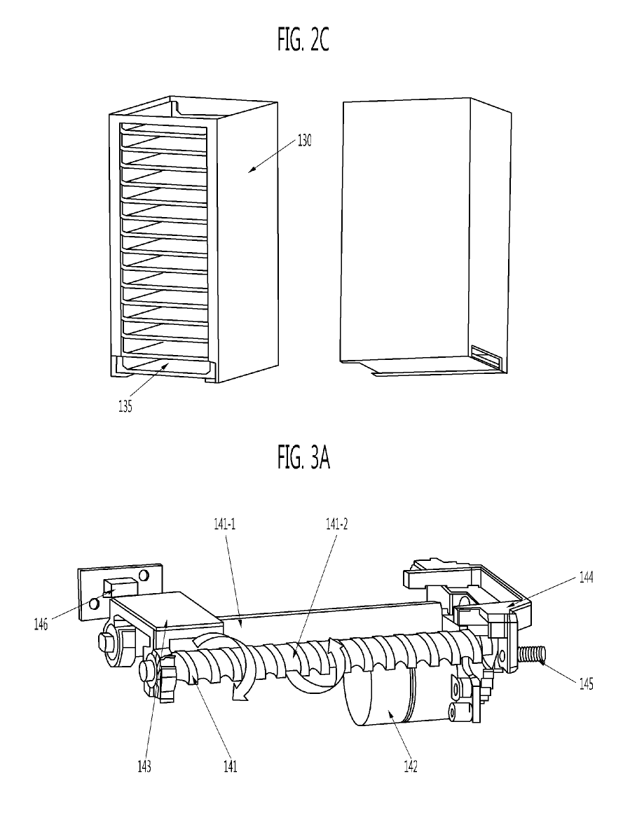

FIG. 2A is a detailed block diagram illustrating a medication supporting system according to an embodiment of the present invention. FIG. 2B is a perspective view illustrating the geometry of a medication supporting apparatus according to an embodiment of the present invention. FIG. 2C is a perspective view illustrating a medicine storage box cartridge of the medication supporting apparatus of FIG. 2B.

Referring to FIGS. 2A through 2C, the medication supporting apparatus 100 according to an embodiment of the present invention includes an output unit 110, an input unit 120, a medicine storage box cartridge 130, a medicine storage box discharge module 140, a communication module 150, a control module 160, a charge opening 104, and a discharge opening 105.

The output unit 110 and the input unit 120 may serve as an interface between the medication supporting apparatus 100 and the user 400. The output unit 110 services medication situations such as medication alarm and warning to the user 400. To this end, the output unit 110 may include a liquid crystal display (LCD) 112 and a light emitting diode (LED) 114, both of which are outputting means. The input unit 120 may receive a discharge instruction of the user (i.e. may reflect a discharge request). To this end, the input unit 120 may include a button 125 as inputting means.

With regard to storage and discharge of medicine, the medication supporting apparatus 100 may include the charge opening 104 for inserting the medicine storage box cartridge (e.g. container) 130 into the medication supporting apparatus 100, and the discharge opening 105 for discharging a medicine storage box 135 in which the medicine is stored.

The medicine storage box cartridge 130 is inserted into the charge opening 104, and may house a plurality of medicine storage boxes 135 in a stacked form. When the medicine is stored, paper dosage bags may be stored in the respective medicine storage boxes 135. The medicine storage boxes 135 may be stored in the medicine storage box cartridge 130 in a stacked fashion. The corresponding storage box cartridge 130 is inserted into the medication supporting apparatus 100 through the charge opening 104. Thereby, the storage is completed.

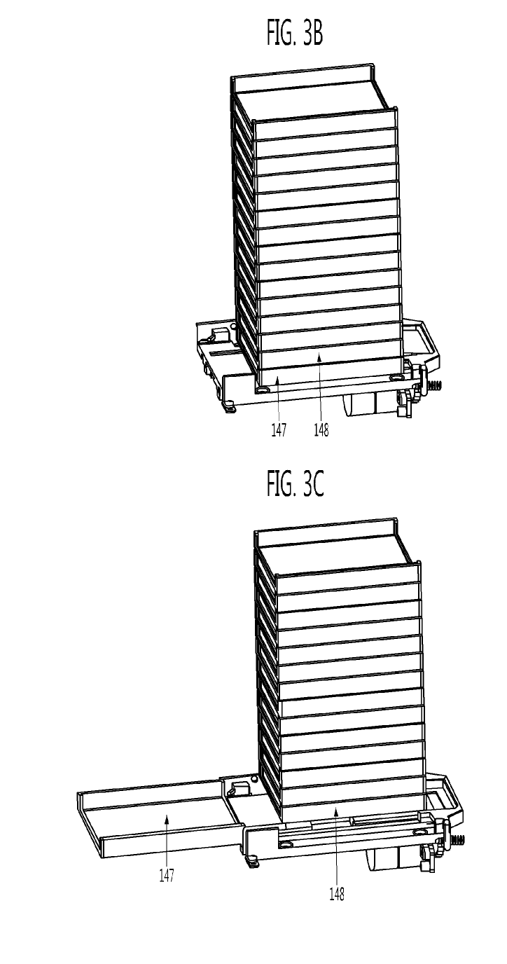

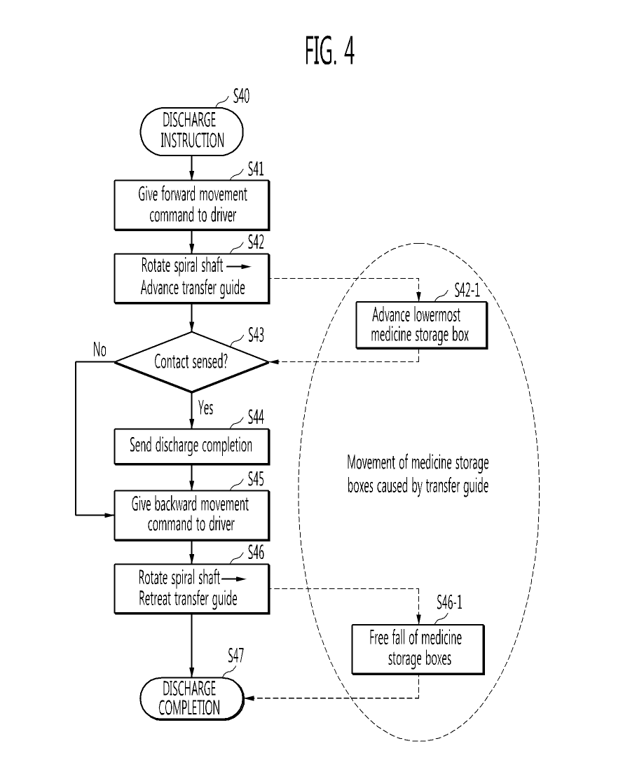

The medicine storage box discharge module 140 may receive the medicine discharge instruction of the user 400 from the input unit 120, thereby discharging the medicine storage box 135 to the outside. A detailed construction of the medicine storage box discharge module 140 will be described with reference to FIG. 3C.

The medicine storage box discharge module 140 is operated to discharge one medicine storage box 135 from the medicine storage box cartridge 130 to the outside of the medication supporting apparatus 100 through the discharge opening 105. To this end, the medicine storage box cartridge 130 may have an open lower end such that one medicine storage box (particularly the lowermost medicine storage box) can be discharged from the medicine storage box cartridge 130.

The communication module 150 may receive a medication related situation from the server 300, and send information about the discharge of the medicine storage box 135 to the server 300 when the medicine storage box 135 is exposed to the outside through the discharge opening 105 of the medicine storage box discharge module 140.

The control module 160 may take charge of data communication with the server 300 and driving commands of the other components of the medication supporting apparatus 100. This control module 160 may be implemented by a printed circuit board (PCB).

FIG. 3A is a perspective view illustrating a medicine storage box discharge module of the medication supporting apparatus of FIG. 2B. FIG. 3B is a perspective view illustrating the state before a medicine storage box is discharged by a medicine storage box discharge module of the medication supporting apparatus of FIG. 2B. FIG. 3C is a perspective view illustrating the state after a medicine storage box is discharged by a medicine storage box discharge module of the medication supporting apparatus of FIG. 2B.

FIG. 4 is a flow chart explaining a method of discharging a medicine storage box in a medication supporting apparatus according to an embodiment of the present invention.

In FIGS. 3B and 3C, for the convenience of description, the medicine storage box cartridge 130 is not shown.

Referring to FIG. 3A, the medicine storage box discharge module 140 includes a spiral shaft 141, a driver 142 driving the spiral shaft 141, a transfer guide 143 connected to the spiral shaft 141, a transfer guide support 144, a spring member 145 connected with the transfer guide support 144, and a switch sensor 146 sensing a contact with the medicine storage box.

The driver 142 may rotate the spiral shaft 141 in a counterclockwise direction (i.e. in an arrow direction 141-1) when the control module gives a forward movement command to the driver 142 according to a medicine discharge instruction of the user.

Further, the driver 142 may rotate the spiral shaft 141 in a clockwise direction (i.e. in an arrow direction 141-2) when the control module gives a backward movement command to the driver 142

The transfer guide 143 is connected to the spiral shaft 141. The transfer guide 143 may move forward toward the discharge opening along the spiral shaft 141 when the spiral shaft 141 is rotated in the counterclockwise direction (i.e. in the arrow direction 141-1) by the driver 142, and move backward toward the transfer guide support 144 along the spiral shaft 141 when the spiral shaft 141 is rotated in the clockwise direction (i.e. in the arrow direction 141-2) by the driver 142.

The transfer guide support 144 is fitted with the transfer guide 143. The transfer guide support 144 is connected to the spring member 145. Thus, the transfer guide support 144 moves further forward by an advancing force when the transfer guide 143 moves forward, and moves further backward by a retreating force when the transfer guide 143 moves backward.

The switch sensor 146 may sense a contact with a lowermost medicine storage box 147 when the lowermost medicine storage box 147 is pushed forward by the forward movement of the transfer guide 143, and the resulting discharge of the lowermost medicine storage box 147. In other words, when the lowermost medicine storage box 147 comes into contact with the switch sensor 146, the switch sensor 146 may sense the discharge of the medicine storage box.

With the use of the aforementioned method, when the transfer guide 143 moves forward or backward, the medicine storage box housed in the medicine storage box cartridge can be discharged by the transfer guide 143.

Referring to FIGS. 3B, 3C, and 4, in the state where the medication supporting apparatus is on standby, the transfer guide 143 is engaged with the transfer guide support 144, and is located at the rear of the lowermost medicine storage box 147.

When a user makes a request for medicine discharge (S40), the control module gives a forward movement command to the driver 142 of the discharge module 140 (S41).

Due to the discharge command of the control module, the driver 142 rotates the spiral shaft 141 in a counterclockwise direction for a predetermined time (S42). Here, the predetermined time refers to a time when the transfer guide 143 reaches the end of a conveyor. As the spiral shaft 141 rotates, the transfer guide 143 moves forward toward the discharge opening.

When the medicine storage boxes are stacked in the medicine storage box cartridge, the lowermost medicine storage box 147 of the medicine storage box cartridge is pushed toward the discharge opening by the forward movement of the transfer guide 143 (S42-1). At this time, the medicine storage box 148 located on the lowermost medicine storage box 147 is put on the transfer guide 143 and the transfer guide support 144.

When the lowermost medicine storage box 147 comes into contact with the switch sensor 146 sensing such a contact while coming out of the discharge opening, the discharge of the medicine storage box is sensed by the switch sensor 146 (S43), and then information about discharge completion is sent to the control module (S44).

When the rotation of the spiral shaft 141 for the predetermined time is completed, the control module gives a backward movement command to the driver 142 (S45).

Due to the backward movement command of the control module, the driver 142 rotates the spiral shaft 141 in a clockwise direction for a predetermined time (S46).

As the spiral shaft 141 rotates, the transfer guide 143 moves backward. When engaged with the transfer guide support 144, the transfer guide 143 pushes the spring member 145 to move backward along with the transfer guide support 144. Then, the discharge instruction of the user is completed (S47). Here, a space corresponding to the discharge medicine storage box is freed, and thus the other medicine storage boxes of the medicine storage box cartridge undergo free fall. Thus, the medicine storage box 148 located on the lowermost medicine storage box takes the position of the lowermost medicine storage box 147, and thus is converted into a standby state (S46-1).

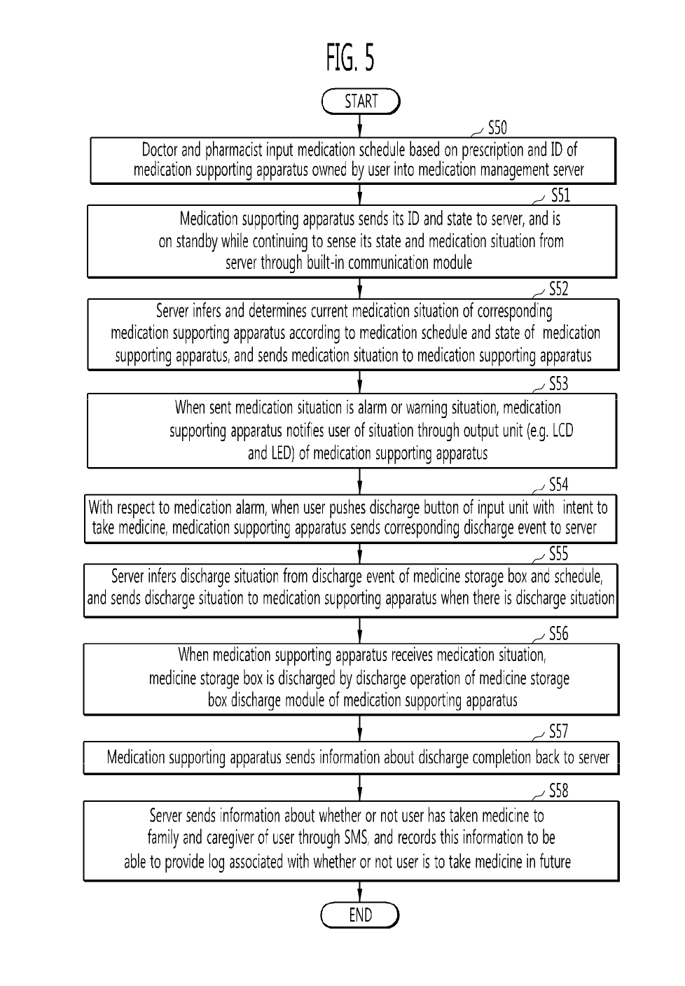

FIG. 5 is a flow chart explaining a method of providing a medication supporting service in a medication supporting system according to an embodiment of the present invention.

Referring to FIG. 5, a doctor and a pharmacist input a medication schedule based on a prescription and an ID of the medication supporting apparatus owned by a user into the medication management server (S50).

The medication supporting apparatus sends its ID and state to the medication management server, and is on standby while continuing to sense its state and a medication situation from the medication management server through the built-in communication module (S51).

The medication management server infers and determines a current medication situation of the corresponding medication supporting apparatus according to the medication schedule and the state of the medication supporting apparatus, and sends the medication situation to the medication supporting apparatus (S52).

When the sent medication situation is an alarm or warning situation, the medication supporting apparatus notifies the user of the situation through the output unit (e.g. LCD and LED) of the medication supporting apparatus (S53).

With respect to the medication alarm, when the user pushes a discharge button of the input unit with intent to take medicine, the medication supporting apparatus sends a corresponding discharge event to the server (S54).

The server infers the discharge situation from the discharge event of the medicine storage box and the schedule, and sends the discharge situation to the medication supporting apparatus when there is a discharge situation (S55).

When the medication supporting apparatus receives the medication situation, the medicine storage box is discharged by discharge operation of the medicine storage box discharge module of the medication supporting apparatus (S56). In this process, the medication supporting apparatus sends information about discharge completion back to the server (S57).

The server sends information about whether or not the user has taken medicine to a family and caregiver of the user through SMS, and records this information to be able to provide a log associated with whether or not the user is to take medicine in the future (S58).

According to the aforementioned medication supporting apparatus and system according to embodiments of the present invention, when any medicine storage box is discharged according to the medication situation, the medicine to be taken at a time is discharged without causing errors such as deformation of the medicine storage box, a phenomenon that the medicine storage box is caught at the discharge opening, or discharge of two or more medicine storage boxes, so that it is possible to reduce medication errors.

Further, by using the stacked storage box cartridge, various kinds of medicine can be stored regardless of the kinds of capsules and pills. The medicine to be taken according to the corresponding medication schedule is correctly discharged, so that it is possible to provide correct medication according to a prescription. This helps regular medication, so that it is possible to provide service for promoting health of the user.

The exemplary embodiment of the present invention described above can also be implemented as a computer program, or as a recording medium on which a computer program is recorded. This will be easily implemented from the disclosure of the above-mentioned exemplary embodiments of the present invention by those skilled in the art.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A medication supporting apparatus comprising:
an output unit providing an alarm and a warning according to a medication situation of a user;
an input unit receiving a medicine discharge instruction from the user;
a medicine storage box cartridge storing a plurality of medicine storage boxes in a stacked fashion; and
a discharge module discharging a lowermost one of the medicine storage boxes of the medicine storage box cartridge to an outside according to the medicine discharge instruction.

2. The medication supporting apparatus according to claim 1, further comprising a communication module receiving the medication related situation from a medication management server, and sending information about the discharge of the medicine storage box to the server when the medicine storage box is discharged.

3. The medication supporting apparatus according to claim 2, further comprising a control module controlling data communication with the server and driving commands of the other components.

4. The medication supporting apparatus according to claim 3, wherein the control module is implemented by a printed circuit board (PCB).

5. The medication supporting apparatus according to claim 1, wherein the medicine storage box cartridge has an open lower end so as to discharge the lowermost medicine storage box to the outside.

6. The medication supporting apparatus according to claim 1, further comprising a charge opening into which the medicine storage box cartridge is inserted.

7. The medication supporting apparatus according to claim 1, further comprising a discharge opening through which the medicine storage box is exposed to the outside.

8. The medication supporting apparatus according to claim 1, wherein the output unit includes a liquid crystal display (LCD) and a light emitting diode (LED).

9. The medication supporting apparatus according to claim 1, wherein the discharge module includes:
a spiral shaft;
a driver driving the spiral shaft;
a transfer guide connected to the spiral shaft, moving forward or backward by rotation of the spiral shaft, and transferring the medicine storage box;
a transfer guide support connected with the transfer guide, and supporting the medicine storage box next above the lowermost medicine storage box when the lowermost medicine storage box is transferred by the forward movement of the transfer guide; and
a spring member connected with the transfer guide support, and causing the transfer guide support to be pushed in a forward or backward direction when the transfer guide moves forward or backward.

10. The medication supporting apparatus according to claim 9, wherein the discharge module further includes a sensor sensing a contact with the discharged lowermost medicine storage box to detect whether or not the lowermost medicine storage box is discharged.

11. A method of discharging a medicine storage box in a medication supporting apparatus, the method comprising:
giving a forward movement command to a driver according to a medicine discharge request of a user;
rotating a spiral shaft in a counterclockwise direction for a predetermined time to advance a transfer guide according to the forward movement command;
pushing the medicine storage box out of a discharge opening by the advancing of the transfer guide, and sending information about completion of discharge when the discharge is sensed by a sensor;
giving a backward movement command to the driver when the rotation of the spiral shaft is completed;
rotating the spiral shaft in a clockwise direction to retreat the transfer guide according to the backward movement command; and
when the transfer guide is engaged with a transfer guide support, pushing a spring member to move the transfer guide support and the transfer guide to a rear of the medicine storage box.

12. The method according to claim 11, wherein the predetermined time is a time when the transfer guide reaches a rear end of a storage box discharge module.

13. A medication supporting system comprising:
a server receiving a medication schedule and a prescription from a doctor or pharmacist and sending information about whether or not a user has taken medicine to a family and caregiver of the user;
an output unit providing an alarm and a warning according to a medication situation of a user;
an input unit receiving a medicine discharge instruction from the user;
a medicine storage box cartridge storing a plurality of medicine storage boxes in a stacked fashion;
a discharge module discharging a lowermost one of the medicine storage boxes of the medicine storage box cartridge to an outside according to the medicine discharge instruction;
a communication module receiving the medication related situation from the server, and sending information about the discharge of the medicine storage box to the server when the medicine storage box is discharged; and
a control module controlling data communication with the server and driving commands of the other components

14. A medication supporting method comprising:
receiving, by a server, medication related details from a doctor or pharmacist and sending the medication related details to a medication supporting apparatus;
providing an alarm and a warning to a user according to the medication related details sent from the server;
discharging a medicine storage box from the medication supporting apparatus according to a medicine discharge instruction of the user;
sending information about the discharge of the medicine storage box to the server; and
notifying, by the server, a caregiver of the user of whether or not the user has taken medicine according to the discharge information.

15. The medication supporting method according to claim 14, wherein the discharging of the medicine storage box includes:
sending the medicine discharge instruction to the server according to the medicine discharge instruction of the user;
inferring, by the server, a discharge situation from the discharge instruction and a schedule, and sending information about the discharge situation to the medication supporting apparatus; and
discharging, by the medication supporting apparatus, the medicine storage box according to the information about the discharge situation.

16. The medication supporting method according to claim 14, wherein the medication related details include a medication schedule and a prescription.

17. The medication supporting method according to claim 14, wherein the caregiver of the user is notified of whether or not the user has taken medication through short message service (SMS).
